(19) United States
(12) Patent Application Publication
(10) Pub. No.: US 2005/0183266 A1
(43) Pub. Date: Aug. 25, 2005

(54) Package opener

(76) Inventor: Gabe Neiser, Port Jefferson Station, NY (US)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/785,686

(22) Filed: Feb. 24, 2004

(51) Int. Cl. B67B 7/00

(52) U.S. Cl. 30/2

(57) ABSTRACT

A clamshell package opener includes a driver gear and an idler gear that are compressed against the die cut edge of the clamshell. As the gears are being compressed to hold the die cut edge, a cutting blade is positioned so as to puncture the clamshell package in the area adjacent the die cut edge and inside the same. Once the clamshell package has been punctured, the driver gear is rotated while the two gears are maintaining frictional engagement with the die cut edge. The rotation of the driver gear causes the die cut edge of the package to pass through the tow gears while being cut by the cutting blade. This action is performed around the die cut edge of the clamshell package until the user may easily remove the contents of the same.

### BACKGROUND OF THE INVENTION

1. Field of the Invention

The present invention relates to clamshell packaging, and more particularly, it relates to an opener for use with clamshell packaging.

2. Description of the Prior Art

The use of clamshell packaging is very widespread throughout the retail industry. The implementation of such packaging has enabled manufacturers to provide safe packaging for their products, while at the same time enable the clear display of the product and/or product inserts without costly additions to the packaging process.

In addition, the technology of the clamshell manufacturing process has also enabled the built in hanger, or feet to allow the package to be hung on a display rack or stand on a display counter without the requirement of additional hangars or supports. Thus, for at least the above reasons, clamshell packages have become commonplace in the retail world.

Clamshell packaging, however, suffers from one major drawback. This is the ability to open these packages that have been heat sealed closed during the manufacturing process. The heat sealing is generally performed along the outer periphery of the clam shell, or the die cut edge flange. The plastic used in these packages is strong and difficult, if not impossible to rip open. As such, the purchaser is often required to cut the package open with a sharp razor blade or knife, which subjects the purchaser to a high possibility of hurting themselves due to the unusual shapes of the clamshell packages. Often times during the opening of these clamshell packages, the purchaser is either injured, or the contents of the package are damaged.

Thus, it would be desirable to provide a tool or device for opening a clamshell package that eliminates the possibility of the purchaser wielding a sharp knife to open the package and which enables the purchaser to easily open the package without damaging the contents thereof.

### SUMMARY OF THE INVENTION

It is therefore an object of the invention to provide a clamshell package opener that provides a safe and easy way for opening such packages.

It is yet another object of the invention to provide a clamshell package opener that does not subject the user to exposure to sharp instruments.

A further object of the invention is to provide a clamshell package opener that does not damage the contents of such package.

These and other objects are achieved in accordance with an embodiment of the invention wherein the clamshell package opener includes means for gripping a die cut edge of the clamshell package, a cutting device for engaging and puncturing the clamshell package in response to closing of said gripping means, and means for advancing the die cut edge of the clamshell package after said cutting device has punctured the package.

In accordance with other embodiments, the clamshell package opener includes a first arm having two opposing ends, a second arm pivotally connected to said first arm and having two opposing ends, a first gear rotatably mounted on one end of said first arm, a second gear rotatably mounted on one end of said second arm that is opposite said first gear, and a cutting device disposed on one of said arms adjacent one of said gears, said cutting device puncturing the clamshell package in an area adjacent the die cut edge when said arms are pivotally closed.

The pivotal closing movement of the first and second arms causes the first and second gears to move closer to each other and engage a die cut edge of the clamshell package disposed there between.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is a perspective view of an exemplary clamshell package;

FIG. 2 is a top view of an exemplary clamshell package;

FIG. 3 is a bottom view of an exemplary clamshell package;

FIG. 4a is a side view of an exemplary clamshell package;

FIG. 4b is an enlarge view of the die cut edge of an exemplary clamshell package;

FIG. 5 is a cross section view of the exemplary clamshell package take along line 5-5 o FIG. 2;

FIG. 6 is a plan view of the clamshell opener according to an aspect of the present invention;

FIG. 7a is a plan view of the top handle of the clamshell opener according to an embodiment of the invention;

FIG. 7b is a plan view of the bottom handle of the clamshell opener according to an embodiment of the invention;

FIG. 8a is a schematic view of the engagement of the clamshell opener and the did cut edge of a clamshell package according to en embodiment of the invention; and

FIG. 8b is a schematic view of the operation of the clamshell opener according to an embodiment of the invention.

### DETAILED DESCRIPTION OF PREFERRED EMBODIMENTS

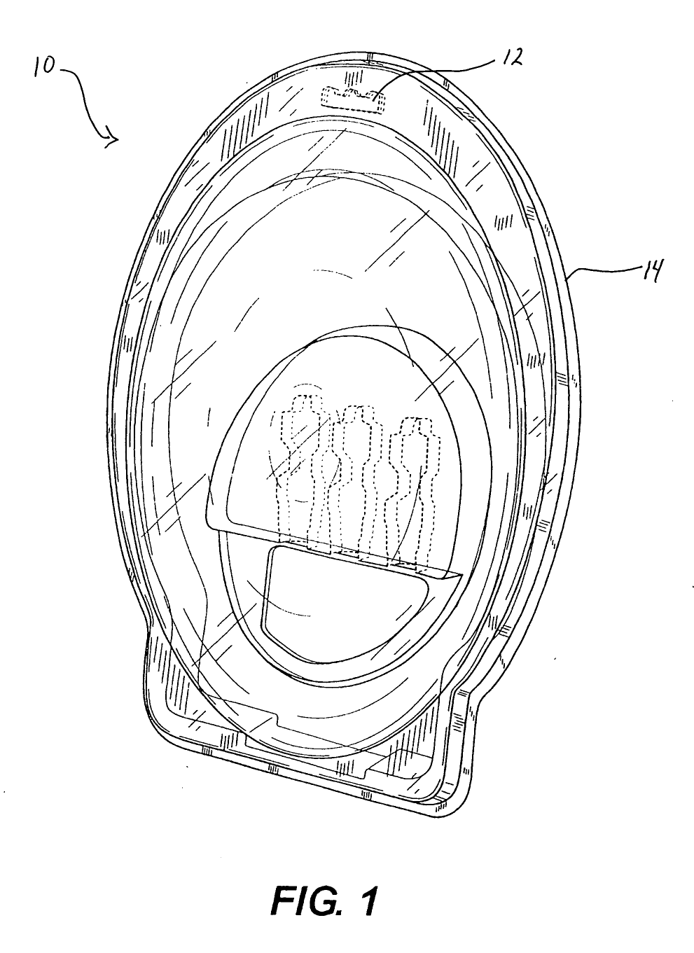

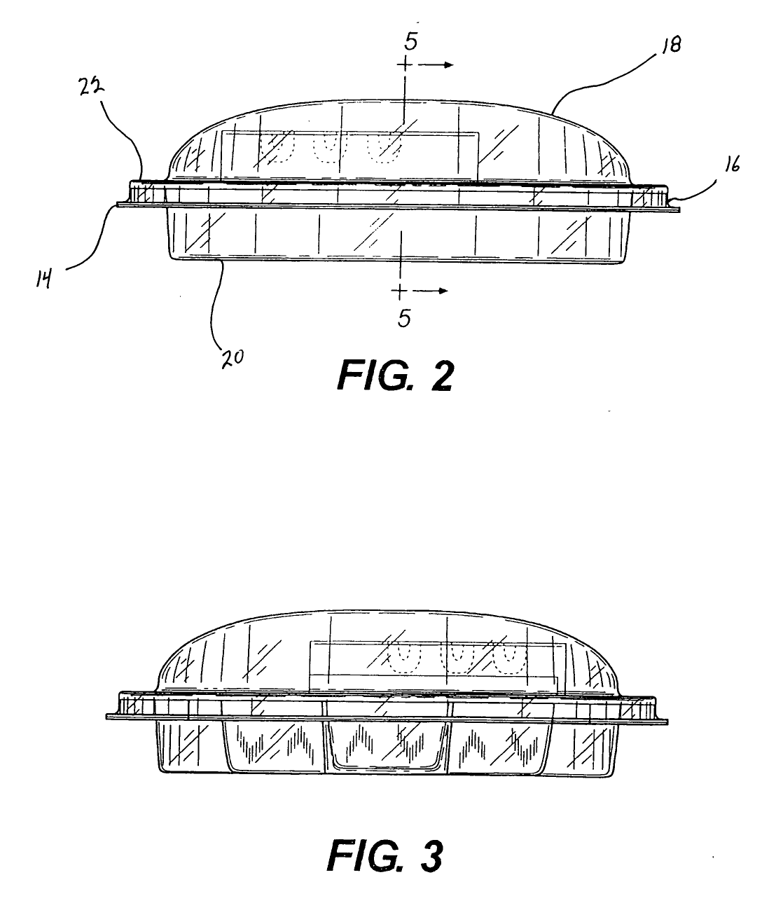

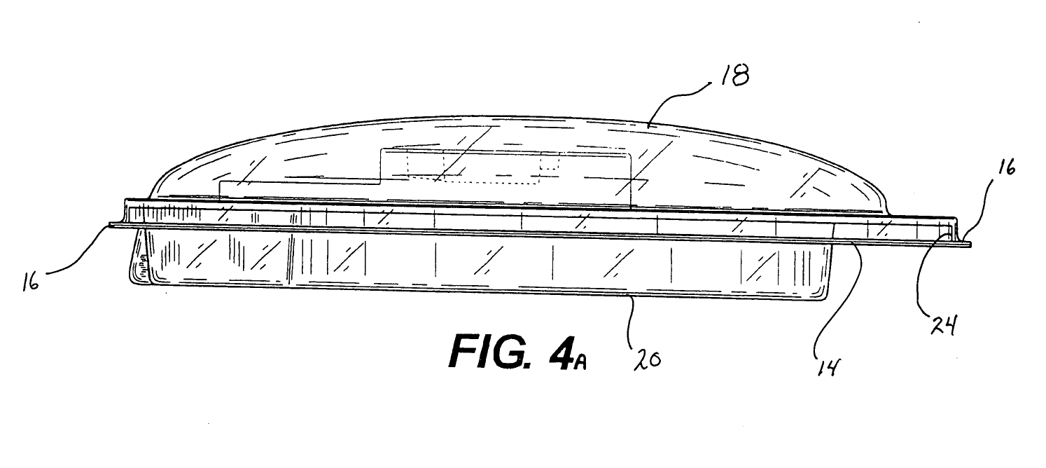

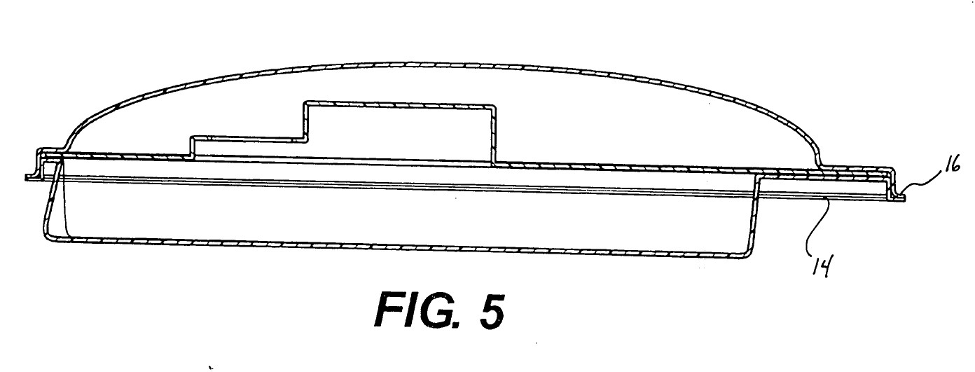

FIGS. 1-5 show an exemplary clamshell package 10 having a die cut edge 14 defining a flange 16 around the entire peripheral edge of the package. A top clam portion 18 is joined with a base portion 20 along a structural flange 22, and adhered to the same via the die cut edge 14. The clamshell package can include a die cut hanging hole 12 for allowing the sealed clamshell package to be hung on a display rack. In other forms (not shown), the clamshell can include molded feet like structures in the bottom which enable the sealed clamshell package to stand on t a display counter, or in a display box.

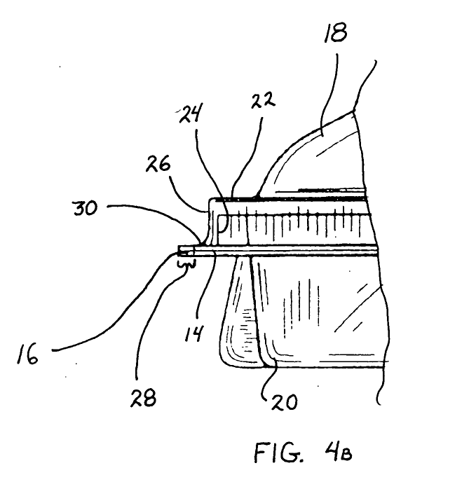

Referring to FIG. 4b, the die cut edge 14 of the flange 16 includes a portion 28 along the outer most periphery where the actual heat is applied and the upper clam 20 and lower package 20 are physically connected. The upper clam 20 has a lower portion 26 that meets with the upper portion 24 of the lower package 18 to form the flange 16 and ultimately the die cut edge 14. As shown, the die cut edge 14 includes the sealed portion 28 and an adjacent portion 30 where the upper claim 20 and lower package 18 are together, but not sealed. It is in this area of adjacent portion 30 where it is preferred to open the package such that any inserts supported by structural flange 22 and/or any products contained in the package are not damaged during opening.

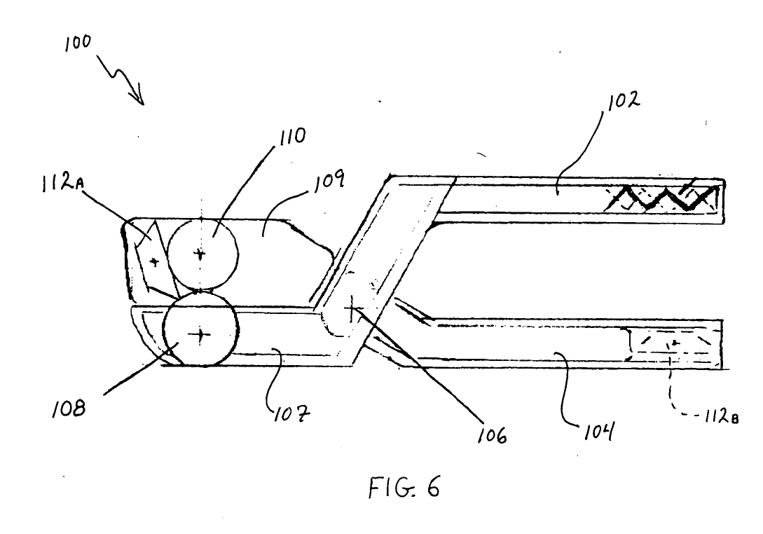

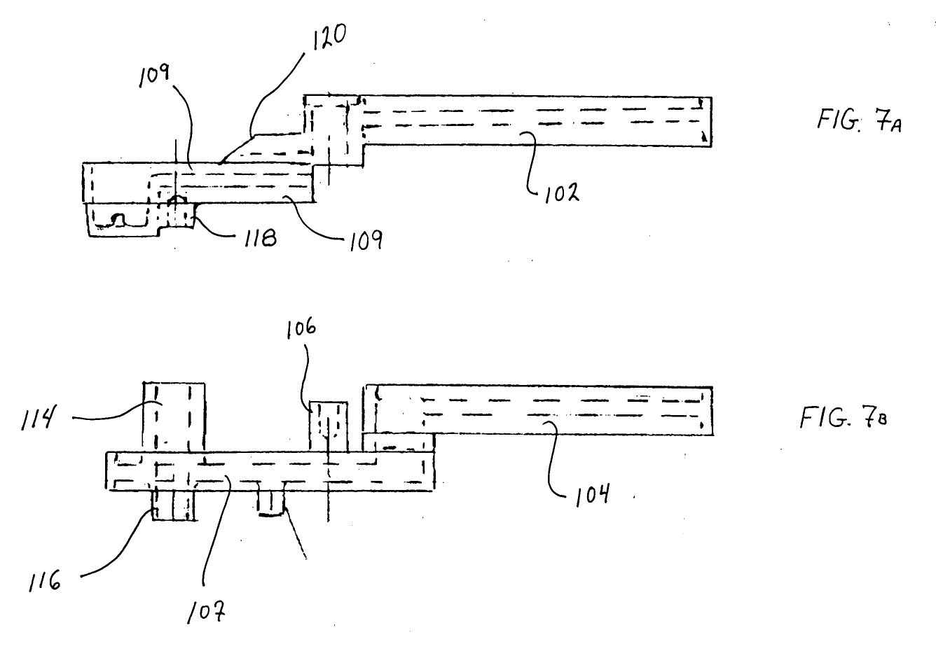

Referring to FIGS. 6 and 7, there is shown a clamshell package opener 100 according to an embodiment of the invention. As shown, the opener 100 includes a scissor like or can opener like construction having a first arm 102 pivotally connected 106 to a second arm 104. The pivot connection 106 between arms 102 and 104 can be any suitable known pivot connection.

First arm 102 includes lower portion 107 that includes a driver gear 108 that is mounted within a driver gear boss 116, and which is driven by a turn handle (not shown) connected to the turn knob boss 114. The second arm 104 includes an upper portion 109 that includes an idler gear 110 and a cutting blade 112a. A second blade 112b can be stored in the handle portion of arm 104 or arm 102, depending on design choices made during manufacturing.

The angular position of the handle arms 102 and 104 with respect to the gears 108 and 110, and the blade 112 can be modified to provide sufficient clearance to the operator while performing the cutting operation and also to allow the clamshell package to pass through the tool unobstructed. By way of example, when the top clam portion 18 or bottom portion 20 are such that they are close to the die cut edge 16, additional clearance of the arms 102 and 104 may be required in order for the tool to engage the die cut edge and move along the same without interfering with the rest of the package.

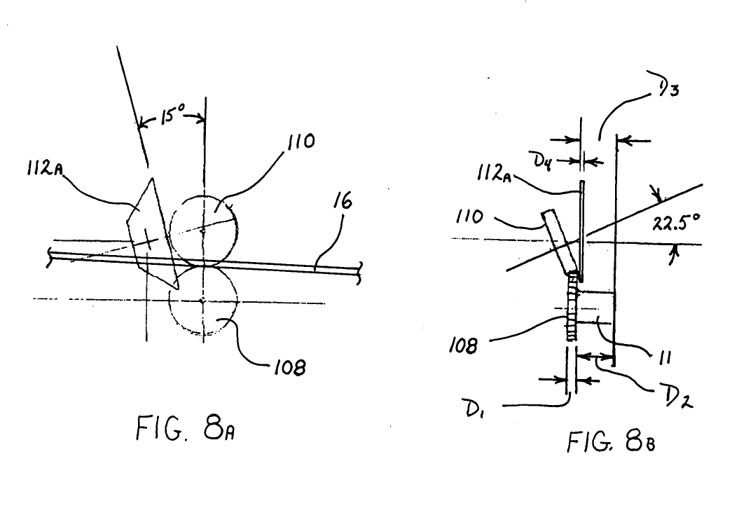

As will be explained with reference to FIGS. 8a and 8b, when the arms 102 and 104 are opened, the driver gear 108 is separated from the idler gear 110 and blade 112a to allow the insertion of the die cut edge flange 16 and die cut edge 14. When the arms 102 and 104 are closed, the driver gear 108 and idler gear 110 secure the clamshell and allow the blade 112a to puncture the flange 16 in the area 30 adjacent the die cut edge 14. This initial puncturing is very integral to the performance and functioning of the clamshell opener 100 according to the invention. Without the initial puncturing, the subsequent operation of the driver and idler gears will not operate in accordance with the invention.

Further closing of the arms forces the driver gear 108 into the bottom side of the die cut edge 14 while the idler gear 110 frictionally engages the upper side of the die cut edge 14. The closing of the arms and frictional engagement of the driver gear 108 and idler gear 110 with the flange 16 provide for clamshell opening operation. Once the initial puncture by blade 112a into the area 30 adjacent the sealed portion 28 is made by the closing of the arms, the driver gear 108 is rotated by the turn knob (not shown) and the frictional engagement of the driver gear and idler gear 110 with the flange 16 causes the tool to advance the flange 16 through the gears and cut the clamshell package in the area 30 adjacent the sealed portion 28 of the flange 16.

Referring to FIG. 8b, there are shown various measurements D1-D4. These measurements are positioned to provide proper operation of the clamshell opener according to the invention. By way of example, D1, which is the thickness of the driver gear 108, must be able to engage the clamshell in the track, D2, which is the distance of the driver gear hub 116 from the face of the tool is to allow the clamshell to clear the holding arms while being cut and passing through, D3, which is the distance between the face of the tool and the blade 112a, is to allow the blade to puncture into the clamshell and be supported by the drive gear 108, and the thickness D4 of the blade 112a is of sufficient strength to puncture the clamshell when the driver gear 108 and idler gear 110 are brought together by closing of arms 102 and 104.

As shown, the idler gear 110 is positioned at an angle with respect to the driver gear 108 and thereby a horizontal line passing there through. The preferred angle for mounting and operation of the idler gear is sufficient to apply pressure to the clamshell and hold it in a horizontal position during cutting. By way of example, the mounting angle of the idler gear 110 can be 22.5 degrees with respect to the horizontal. The angular mounting of the idler gear 110 with respect to the driver gear 108 facilitates movement of the flange 16 through the gears and thereby enables the cutting of the clamshell package.

The materials that idler gear 110 and driver gear 108 are made of can be a matter of design choice. However it has been determined by testing, that the idler gear 110 is preferably made of a non-skid material and which has a sufficiently high coefficient of friction so that it may compress against the package flange 16 during operation and thereby provides an increased frictional engagement between the opener and the package. Driver gear 108 can be a serrated wheel that is made of metal or other material that can dig into the plastic clamshell to provide traction during operation of the opener.

While there have been shown, described and pointed out fundamental novel features of the invention as applied to preferred embodiments thereof, it will be understood that various omissions, substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed, described or suggested form or embodiment as a general matter of design choice. It is the intention, therefore, to be limited only as indicated by the scope of the claims appended hereto.

1. A clamshell package opener comprising:
means for gripping a die cut edge of the clamshell package;
a cutting device for engaging and puncturing the clamshell package in response to closing of said gripping means; and
means for advancing the die cut edge of the clamshell package after said cutting device has punctured the package.

2. The clamshell package opener according to claim 1, wherein said means for gripping comprises:
a first gear; and
a second gear mounted such that said first and second gears are closeable so as to engage the die cut edge of the clamshell package there between.

3. The clamshell package opener according to claim 2, wherein said first gear comprises an idler gear and said second gear comprises a driver gear.

4. The clamshell package opener according to claim 2, wherein said advancing means comprises a handle for rotating at lease one of said first and said second gears.

5. The clamshell package opener according to claim 2, wherein said cutting device punctures an area adjacent said die cut edge when said idler gear and said driver gear are closed onto and engages said die cut edge.

6. A clamshell package opener comprising:
a first arm having two opposing ends;
a second arm pivotally connected to said first arm and having two opposing ends;
a first gear rotatably mounted on one end of said first arm;
a second gear rotatably mounted on one end of said second arm that is opposite said first gear, wherein pivotal closing movement of said first and second arms causes said first and second gears to move closer to each other and engage a die cut edge of the clamshell package disposed there between; and
a cutting device disposed on one of said arms adjacent one of said gears, said cutting device puncturing the clamshell package in an area adjacent the die cut edge when said arms are pivotally closed.

7. The clamshell package opener according to claim 6, further comprising driving means for advancing the die cut edge of the clamshell package through closed first and second gears.

8. The clamshell package opener according to claim 7, wherein said first gear comprises an idler gear and said second gear comprises a driver gear, said driving comprising said driver gear and means for rotating said driver gear.

9. The clamshell package opener according to claim 8, wherein said rotating means comprises a handle rotatably connected to said driver gear through said
